(19) United States
(12) Patent Application Publication
(10) Pub. No.: US 2007/0189138 A1
(43) Pub. Date: Aug. 16, 2007

(54) Information recording device and method, and computer program

(75) Inventors: Kazuo Kuroda, Saitama (JP); Kunihiko Horikawa, Saitama (JP); Masahiro Kato, Saitama (JP); Toshio Suzuki, Saitama (JP); Eiji Muramatsu, Saitama (JP); Shoji Taniguchi, Saitama (JP)

Correspondence Address: YOUNG & THOMPSON, 745 SOUTH 23RD STREET, 2ND FLOOR, ARLINGTON, VA, 22202, US

(73) Assignee: PIONEER CORPORATION, Tokyo (JP)

(21) Appl. No.: 10/592,368

(22) PCT Filed: Mar. 9, 2005
(86) PCT No.: PCT/JP05/04131

§ 371 Date: Feb. 12, 2007

(30) Foreign Application Priority Data
Mar. 12, 2004 (JP) 2004-070392

(51) Int. Cl. G11B 7/12

(52) U.S. Cl. 369/47.51; 369/53.26; 369/94

(57) ABSTRACT

An information recording device (1) includes: recording elements (501) for recording information on an information recording medium by recording layer light having adjustable recording power; optimization elements (571) for controlling the recording elements so as to modify the recording power at least into several levels and recording real data corresponding to the data used by the recording elements when recording information; and adjusting elements (504) for adjusting the recording power in the recording elements to be an optimal value.

### TECHNICAL FIELD

The present invention relates to an information recording apparatus, such as a DVD recorder, for example, an information recording method, an information recording/reproducing apparatus, an information recording/reproducing method, and a computer program which makes a computer function as the information recording apparatus or the information recording/reproducing apparatus.

### BACKGROUND ART

On an information recording/reproducing apparatus for recording information onto an information recording medium, such as an optical disc, for example, an optimum power of a recording power related to laser light for recording is set by an OPC (Optimum Power Control) process, according to the type of the optical disc, the type of the information recording/reproducing apparatus, the recording speed and the like. Namely, calibration of the recording power is performed. By this, it is possible to realize a proper recording operation corresponding to variations or the like in features of an information recording surface of the optical disc. For example, if the optical disc is loaded to an apparatus main body and a write command is inputted, light intensity related to the laser light for recording is changed sequentially step-by-step, and test writing data is recorded into an OPC area (Power Calibration Area), and a so-called test writing process is performed. After that, the test writing data recorded in this manner (OPC pattern) is reproduced. The reproduction result is judged by a predetermined evaluation standard, to thereby set the optimum power.

Moreover, the optimum power related to the laser light for recording can be set even by OPC performed simultaneously with an actual recording operation (so-called running OPC).

Patent document 1: Japanese Patent Publication NO. 3159454

### DISCLOSURE OF INVENTION

### Subject to be Solved by the Invention

However, in the above-mentioned OPC, the optimum power is calculated by using the test writing data. On the other hand, when the recording operation is actually performed, the recording is performed by using actual data. Thus, there is such a technical problem that the optimum power is not always obtained, due to a difference between the test writing data and the actual data. Moreover, in the above-mentioned OPC, the calibration is performed by recording the test writing data in the OPC area located in a predetermined position of a disc, for example. However, because of variations or the like in manufacturing conditions in the manufacturing process of the disc, there is such a technical problem that recording features are not uniform throughout the entire surface of the disc. Thus, there is such a technical problem that the optimum power cannot be set even by the OPC in the OPC area, in a portion located relatively far away from the OPC area.

Moreover, even in the running OPC, in the case where the data is recorded by using the laser, for example, since it is only measuring quantity of reflected light in the recording operation, there is such a technical problem that the optimum power is not always obtained.

In order to solve the above-mentioned conventional problem, it is therefore an object of the present invention to provide an information recording apparatus and an information recording method, which enable recording of information with a more optimum recording power, for example, and a computer program which makes a computer as such an information recording apparatus.

### MEANS FOR SOLVING THE SUBJECT

### Information Recording Apparatus

The above object of the present invention can be achieved by an information recording apparatus provided with: a recording device for recording information onto an information recording medium by using laser for recording with an adjustable recording power; an optimizing device for recording actual data corresponding data used when the recording device records the information, while at least changing the recording power in a plurality of ways by controlling the recording device, and for obtaining an optimum value of the recording power; and an adjusting device for adjusting the recording power of the recording device to be the obtained optimum value.

According to the information recording apparatus of the present invention, various information which includes content information including video information, audio information, data information for a computer or the like, is recorded onto the information recording medium, such as a DVD and a CD, by the recording device constructed from an optical pickup, a buffer, an encoder or the like, for example. At this time, the recording device records the various information, by irradiating the information recording medium with the laser light for recording.

Particularly in the present invention, there is provided the optimizing device including a CPU, an envelope detector or the like, for example. It is constructed to obtain the optimum value of the recording power, by recording the actual data corresponding to the data actually used when the recording device performs the information recording operation. More specifically, the optimizing device firstly records the actual data for adjusting the recording power, onto the information recording medium. Incidentally, if a DVD is taken as an example of the information recording medium, for example, the data obtained by appending ECC data to predetermined data and DVD-modulating it, is used as the actual data. Namely, the same data is recorded as in the case where the actual content information or the like is recorded. In this regard, it is different from the normal OPC (or running OPC) which uses the data different from the actual content information or the like. Then, on the basis of the recorded actual data, the optimum value is obtained. In this case, the optimum value may be obtained in the same operation as the OPC.

Then, the adjusting device including a CPU, a driver/strategy circuit or the like, adjusts the recording power of the recording device, to be the optimum value obtained by the optimizing device. By this, the optimum value is obtained by using the actual data, not by using a special recoding pattern as in the normal OPC. Therefore, it is possible to record the information with the recording power related to the optimum value which meets actual recording conditions.

Incidentally, there is the “running OPC” as a technology of adjusting the recording power during the recording. This is, however, merely recognizing the recording state on the information recording medium and adjusting the recording power, as occasion demands, by detecting the quantity of reflected light of the recording laser while recording the information. In the present invention, however, since the actual data is recorded during the recording and the recording power is adjusted on the basis of the actual data, there is such a great advantage that it is possible to obtain the optimum value more suitable for the conditions in the actual recording.

Consequently, according to the information recording apparatus of the present invention, it is possible to adjust the recording power suitable for the actual recording conditions, i.e. more preferably, by adjusting the recording power by using the actual data.

Incidentally, the adjustment of the recording power may be performed in each predetermined cycle or irregularly. Moreover, it may be performed in response to an instruction from a user of the information recording apparatus or it may be automatically performed by an instruction from a microcomputer or the like, for example. Alternatively, it may be performed if the recording position of the information recorded by the recording device is greatly changed (e.g. in the case of a disc-shaped disc described later, if the recording position is changed from the inner to the outer circumferential side).

In one aspect of the information recording apparatus of the present invention, it is further provided with a calibrating device for obtaining a calibration value of the recording power by using a predetermined recording pattern, the optimizing device changing the recording power in a plurality of ways on the basis of the calibration value of the recording power obtained by the calibrating device.

According to this aspect, it is possible to obtain the optimum value on the basis of the calibration value of the recording power obtained in advance by the normal OPC or the like, for example. At that time, considering that the calibration value is the value of the recording power which is proper to some extent, if the recording power is changed in a plurality of ways on the basis of the calibration value, then, it is possible to reduce a processing load related to the change of the recording power.

In another aspect of the information recording apparatus of the present invention, the optimizing device records the optimum value onto the information recording medium together with apparatus identification information, by controlling the recording device.

According to this aspect, by reading the apparatus identification information, it is possible to record the information with the recording power corresponding to the optimum value, relatively easily. Moreover, since the optimum value and the apparatus identification information are recorded on the information recording medium, it is possible to record the information with the recording power corresponding to the optimum value, regardless of the type of the information recording apparatus or the like.

In another aspect of the information recording apparatus of the present invention, the optimizing device changes the recording power in a plurality of ways on the basis of the obtained optimum value when the obtained optimum value is recorded on the information recording medium.

According to this aspect, since a new optimum value can be obtained on the basis of the optimum value obtained by the optimizing device, it is possible to reduce a processing load for obtaining the optimum value.

In an aspect of the information recording apparatus in which the recording power is changed in a plurality of ways on the basis of the optimum value, as described above, the optimizing device may change the recording power in a plurality of ways on the basis of the obtained calibration value when the obtained optimum value is not recorded but the obtained calibration value is recorded on the information recording medium.

By virtue of such construction, even without the optimum value obtained by the optimizing device, since a new optimum value can be obtained on the basis of the calibration value obtained by the calibrating device, it is possible to reduce a processing load for obtaining the optimum value.

In another aspect of the information recording apparatus of the present invention, the optimizing device obtains the optimum value by recording the actual data into a data recording area which is a portion where content information out of the information is recorded.

According to this aspect, since the optimum value is obtained by recording the actual data into the data recording area where the actual content information, such as a movie and music, is recorded, it is possible to obtain the optimum value which further meets the state of the actual recording. Incidentally, in the calibration by the normal OPC (i.e. calibration performed in advance), the optimum value is obtained by recording the data for OPC not into the data recording area but into a management information area described later (e.g. a lead-in area, etc.). However, depending on a difference in recording features in respective partial areas of the information recording medium, the optimum value obtained in this manner does not always allow preferable recording throughout the entire information recording medium. In this aspect, however; since the calibration can be performed in the data recording area where the information is actually recorded, it is possible to obtain the recording power uninfluenced by the recording features in respective partial areas of the information recording medium.

Moreover, in the case of an information recording medium having a plurality of recording layers, it is possible to obtain the more preferable optimum value in each layer, by recording the actual data into each layer. Moreover, if the optimum value is obtained in a plurality of points in the data recording area, it is possible to perform the more preferable recording operation, by using at least one of a plurality of optimum recording powers in respective partial areas.

In an aspect of the information recording apparatus in which the actual data is recorded into the data recording area, as described above, the optimizing device may obtain the optimum value by recording the actual data into a recording area which is located in the data recording area and which is adjacent to a recording area where the information is to be recorded by the recording device after the optimum value is obtained.

By virtue of such construction, it is possible to obtain the optimum value in view of the recording features in the recording area where the recording operation is performed. Namely, it is possible to realize the more optimum recording power, in accordance with a difference in recording features in respective portions of the recording area of the information recording medium, which cannot be considered in the normal OPC.

Incidentally, the expression “recording area . . . which is adjacent to . . . ” is a wide concept not only including a literal meaning of adjacent recording area, but also including a nearby portion whose recording features are approximately the same as those of a position where the recording is to be performed.

In an aspect of the information recording apparatus in which the actual data is recorded into the data recording area, as described above, it may be further provided with: a judging device for judging whether or not reproduction can be performed in the portion where the actual data is recorded; and a controlling device for controlling the recording device to register the portion where the actual data is recorded, as an unusable area, if it is judged that reproduction cannot be performed by the judging device.

By virtue of such construction, it is possible to prevent a disadvantage of incorrect reproduction of the portion where the actual data is recorded in order to obtain the optimum value and where reproduction cannot be performed. As a result, it is possible to enable an information reproducing apparatus, for example, to properly reproduce it afterward.

In an aspect of the information recording apparatus in which the registration as the unusable area is performed, as described above, the information recording medium may be a multilayer information recording medium, and the controlling device may control the recording device to also register a recording area in another layer corresponding to the recording area in one layer, where the actual data is recorded, which is registered as the unusable area, as an unusable area.

By virtue of such construction, even if the actual data is recorded into one layer, for example, it is possible to hinder a possible influence of the actual data recoding into the one layer on another layer, and it is possible to record the information more reliably. More specifically, in the case of an information recording medium having two recording layers, for example, if the actual data is recorded into the recording layer located on the rear side viewed from the recording device, it is predicted that the actual data recording has some influence not only on the rear recording layer, but also on the front recording layer located between the recording device and the rear recording layer. In this case, out of the front recording layer, the recording area for which some influence thereon is predicted is registered as the unusable area.

Incidentally, the expression that “a recording area in another layer corresponding to the recording area in one layer, where the actual data is recorded, which is registered as the unusable area” is such a concept that if the actual data is recorded into the recording area in a position with a track number 100 in one layer, then, not only the recording area in a position with a track number 100 in another layer, but also a surrounding recording area portion for which some influence thereon by the actual data recording is predicted are registered as the unusable area. Namely, the expression “corresponding to” in the present invention is a concept which can include not only the recording area in another layer with the same track number as that of one layer, for example, but also the surrounding recording area portion which is possibly influenced by the actual data recording. However, obviously, registering the recording area in another layer with the same track number as that of one layer as the unusable area, is also within a scope of the present invention.

In an aspect of the information recording apparatus in which the information is recorded onto the multilayer information recording medium, as described above, the judging device may judge that reproduction cannot be performed if the optimizing device records the actual data with a larger value of recording power than the optimum value.

For example, if the actual data is recorded with the larger value of recording power than the case of the normal recording operation (e.g. the recording operation by using the recording power with the optimum value), there is a possibility that the recording layer is destroyed or damaged in the portion where the actual data is recorded. Therefore, by virtue of such construction, it is possible to properly register the recording area in which the recording layer is possibly damaged, as the unusable area. Moreover, even if reproduction is not actually performed in the recording area where the actual data is actually recorded, by referring to the recording power when the actual data is recorded, it is possible to judge whether or not reproduction can be performed, relatively easily.

In another aspect of the information recording apparatus of the present invention, the optimizing device obtains the optimum value by recording the actual data into a management information area which is a portion where management information about reproduction of content information is recorded out of the information.

According to this aspect, it is possible to record the actual data for obtaining the optimum value, which is originally not the content information or the like, separately from the content information or the like. Therefore, it is possible to prevent such a disadvantage that the actual data is incorrectly accessed and the reproduction of the content information is hindered during the reproduction of the content information.

In an aspect of the information recording apparatus in which the actual data is recorded into the management information area, as descried above, the information recording medium may be provided with a plurality of management information areas, and the optimizing device may record the actual data into one management information area relatively close to a recoding area where the information is to be recorded by the recording device after the optimum value is obtained, out of the plurality of management information areas.

By virtue of such construction, it is possible to record the actual data in a position closer to the recording area where the information is to be recorded, and obtain the optimum value in view of the recording features or the like of the position. More specifically, as described later, for example, in the case of an information recording medium having a lead-in area and a lead-out area, which are one example of the management information area, if the recording area where the information is to be recorded is closer to the lead-in area, the actual data is preferably recorded into the lead-in area. On the other hand, if it is closer to the lead-out area, the actual data is preferably recorded into the lead-out area. Therefore, even if the actual data is not recorded into the data recording area, as described above, it is possible to obtain the more preferable optimum value.

In another aspect of the information recording apparatus of the present invention, the information recording medium is provided with an additional recording management area related to additional recording of the information, and the optimizing device obtains the optimum value by recording the actual data into the additional recording management area adjacent to a data recoding area where the information to be additionally recorded is recorded.

According to this aspect, since the actual data is recorded into the additional recording management area adjacent to the data recording area where the information is to be recorded from now, it is possible to obtain the more preferable optimum value, in view of a difference in recording features caused by a difference in recording position.

In another aspect of the information recording apparatus of the present invention, the optimizing device obtains the optimum value by measuring at least one of jitter and asymmetry, which are obtained by reading the actual data, and a reading error rate when the actual data is read.

According to this aspect, it is possible to adjust the recording power so as to reduce the jitter, minimize the asymmetry or minimize the error rate, for example, on the basis of the parameters measured by the optimizing device. As a result, it is possible to obtain the more preferable optimum value. Incidentally, the jitter, the asymmetry and the error rate will be explained in detail in an embodiment described later.

Incidentally, in another aspect of the information recording apparatus of the present invention, the optimizing device records the optimum value onto the information recording medium by controlling the recording device.

According to this aspect, the optimizing device can refer to the data related to the optimum value obtained by recording the actual data in the past, relatively easily, and it can obtain the optimum value from the actual data recorded with the more preferable recording power, with reference to the recorded optimum value. Incidentally, the position where the optimum value is recorded may be in the data recording area, the management information area or another area. In short, it is only necessary that the optimum value is recorded on the information recording medium, and that it can be used by reading it. In addition, if the information recording apparatus is provided with a storing device for recording the optimum value therein (e.g. a RAM, a flush memory, a hard disk, etc.), the optimum value may be recorded into the storing device.

(Information Recording Method)

The above object of the present invention can be also achieved by an information recording method in an information recording apparatus provided with: a recording device for recording information onto an information recording medium by using laser for recording with an adjustable recording power, the information recording method provided with: an optimizing process of recording actual data corresponding data used when the recording device records the information, while at least changing the recording power in a plurality of ways by controlling the recording device, and of obtaining an optimum value of the recording power; and an adjusting process of adjusting the recording power of the recording device to be the obtained optimum value.

According to the information recording method of the present invention, the optimum value is obtained by recording the actual data in the optimizing process, and the recording power of the recording device is adjusted in the adjusting process. Therefore, it is possible to receive the same various benefits as those of the information recording apparatus of the present invention described above.

Incidentally, in response to the above-mentioned various aspects of the information recording apparatus of the present invention, the information recording method of the present invention can also adopt various aspects.

(Computer Program)

The above object of the present invention can be also achieved by a computer program for recording control to control a computer provided in the above-mentioned information recording apparatus of the present invention (including its various aspects), the computer program making the computer function as at least one portion of the recording device, the optimizing device, and the adjusting device.

According to the computer program of the present invention, the above-mentioned information recording apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the above-mentioned various aspects of the information recording apparatus of the present invention, the computer program of the present invention can also adopt various aspects.

The above object of the present invention can be also achieved by a computer program product in a computer-readable medium for tangibly embodying a program of instructions executable by a computer provided in the information recording apparatus of the present invention (including its various aspects), the computer program product making the computer function as at least one portion of the recording device, the optimizing device, and the adjusting device.

According to the computer program product of the present invention, at least one portion of the recording device, the optimizing device, and the adjusting device of the present invention described above can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as at least one portion of the recording device, the optimizing device, and the adjusting device.

These effects and other advantages of the present invention become more apparent from the following embodiment.

As explained above, according to the information recording apparatus of the present invention, it is provided with: the recording device; the optimizing device; and the adjusting device, and according to the information recording method of the present invention, it is provided with: the optimizing process; and the adjusting process. Therefore, it is possible to perform adjustment suitable for the actual recording conditions, by adjusting the recording power by using the actual data.

### BRIEF DESCRIPTION OF DRAWINGS

FIG. 1 is a substantial plan view showing the basic structure of an optical disc used in an embodiment of the information recording apparatus of the present invention, the optical disc having a plurality of recording areas, in the upper part, in association with a schematic conceptual view showing a recording area structure in the radial direction in the lower part.

FIG. 2 is a block diagram conceptually showing the basic structure of the information recording apparatus in the embodiment of the present invention.

FIG. 3 is a flowchart showing a flow of an entire recording operation of the information recording apparatus in the embodiment.

FIG. 4 is a flowchart showing a flow of an entire OPC operation of the information recording apparatus in the embodiment.

FIG. 5 is a flowchart showing a flow of an actual data OPC operation of the information recording apparatus in the embodiment.

FIG. 6 is one data structure diagram conceptually showing a data structure and an area used by the actual data OPC, on the optical disc onto which the data is recorded by the information recording apparatus in the embodiment.

FIG. 7 are other data structure diagrams conceptually showing a data structure and an area used by the actual data OPC, on the optical disc onto which the data is recorded by the information recording apparatus in the embodiment.

FIG. 8 are other data structure diagrams conceptually showing a data structure and an area used by the actual data OPC, on the optical disc onto which the data is recorded by the information recording apparatus in the embodiment.

FIG. 9 is another data structure diagram conceptually showing a data structure and an area used by the actual data OPC, on the optical disc onto which the data is recorded by the information recording apparatus in the embodiment.

FIG. 10 is another data structure diagram conceptually showing a data structure and an area used by the actual data OPC, on the optical disc onto which the data is recorded by the information recording apparatus in the embodiment.

FIG. 11 are other data structure diagrams conceptually showing a data structure and an area used by the actual data OPC, on the optical disc onto which the data is recorded by the information recording apparatus in the embodiment.

FIG. 12 is a flowchart showing a flow related to another example of the actual data OPC process of the information recording apparatus in the embodiment.

FIG. 13 are other data structure diagrams conceptually showing a data structure and an area used by the actual data OPC, on the optical disc onto which the data is recorded by the information recording apparatus in the embodiment.

FIG. 14 is another data structure diagram conceptually showing a data structure and an area used by the actual data OPC, on a Multi Border optical disc onto which the data is recorded by the information recording apparatus in the embodiment.

### DESCRIPTION OF REFERENCE CODES

1 information recording apparatus
100 optical disc
104; 114, 124 lead-in area
108, 118, 128 lead-out area
110, 120 OPC area
111, 121 defect management area
112, 122 control information area
113, 123 file system
119, 129 spare area
501 optical pickup
504 driver/strategy circuit
506 DVD modulator
507 data ECC generator
560 CPU
570 OPC pattern generator
571 envelope detector

### BEST MODE FOR CARRYING OUT THE INVENTION

Hereinafter, the best mode for carrying out the present invention will be explained in each embodiment in order, with reference to the drawings.

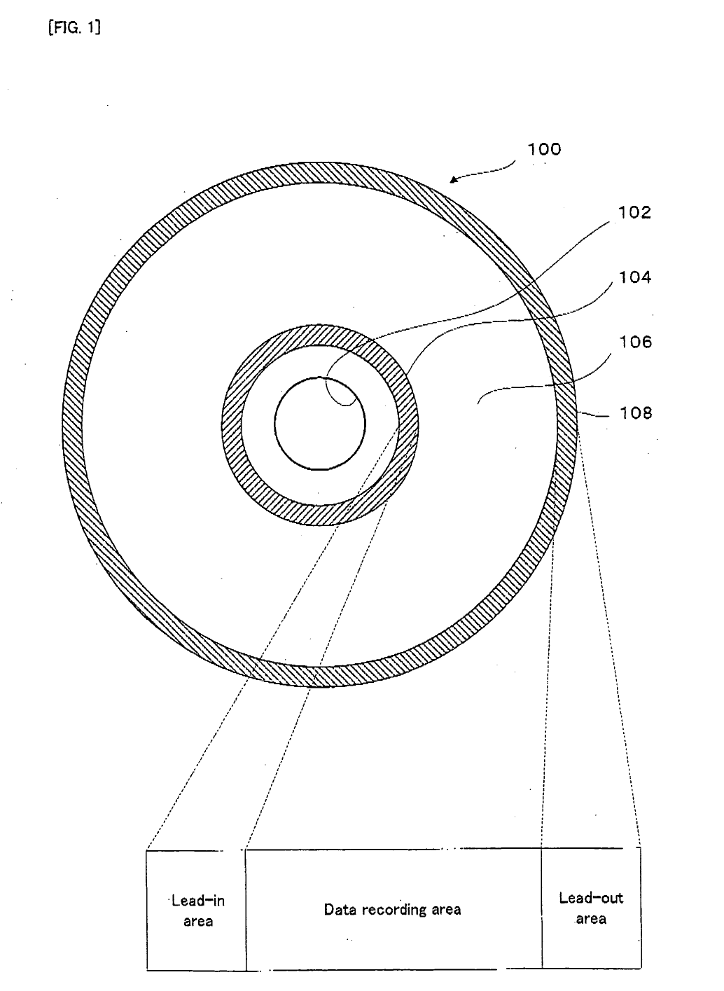

Firstly, the information recording medium used in an embodiment of the information recording apparatus of the present invention will be explained with reference to FIG. 1. FIG. 1 is a substantial plan view showing the basic structure of an optical disc used in the embodiment of the information recording apparatus of the present invention, the optical disc having a plurality of recording areas, in the upper part, in association with a schematic conceptual view showing a recording area structure in the radial direction in the lower part.

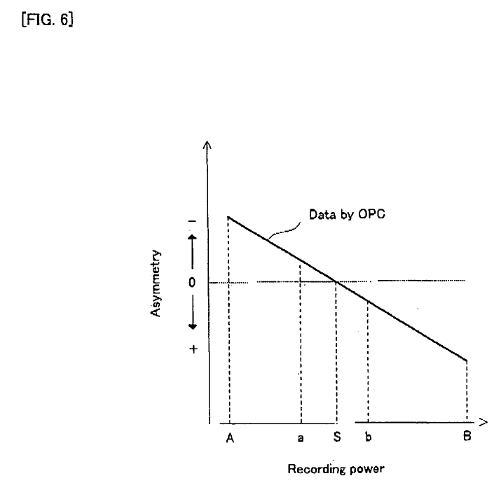

As shown in FIG. 1, an optical disc 100 is recordable in various recording methods, such as a magneto optical method and a phase change method, on which recording (writing) can be performed a plurality of times or only once, for example. The optical disc 100 has a recording surface on a disc main-body with a diameter of about 12 cm, as is a DVD. On the recording surface, the optical disc 100 is provided with: a center hole 102 as the center; a lead-in area 104; a data recording area 106; and a lead-out area 108, from the inner to the outer circumference. In each area, a groove track and a land track are alternately placed, spirally or concentrically, centered on the center hole 102, for example. The groove track may be wobbled, and a pre-pit may be formed on one or both of the tracks. Incidentally, the present invention is not particularly limited to the optical disc having these three areas. For example, even if the lead-in area 104 or the lead-out area 108 does not exist, a file structure explained below can be constructed. Moreover, as described later, the lead-in area 104 or the lead-out area 108 may be further segmentized (refer to FIG. 6, etc.).

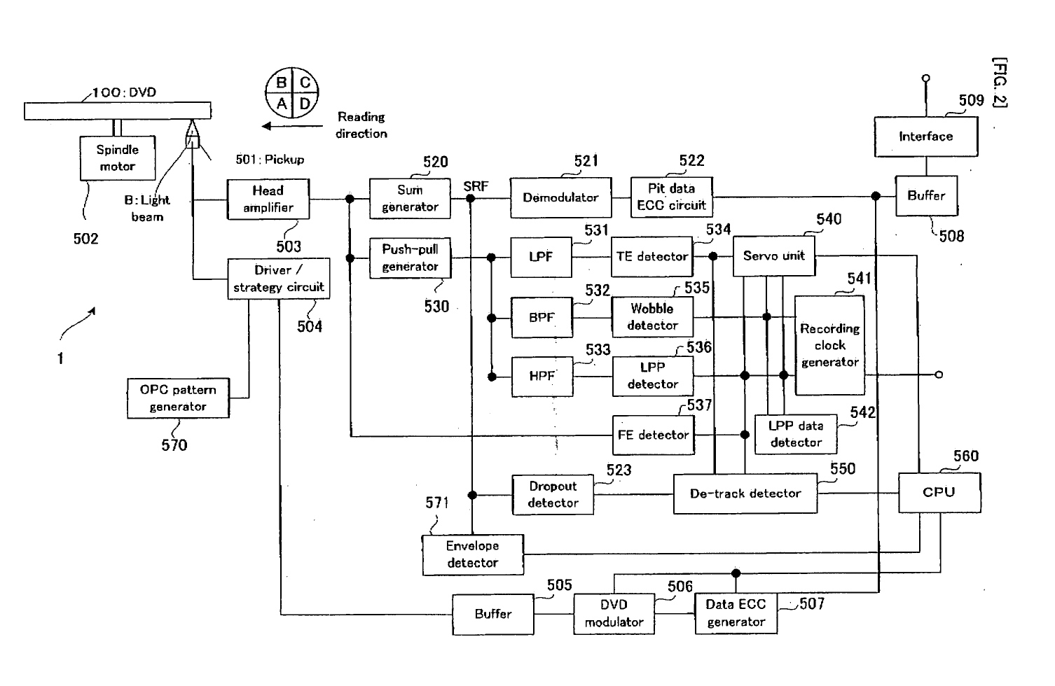

Next, with reference to FIG. 2 to FIG. 13, the embodiment of the information recording apparatus of the present invention will be explained.

(Basic Structure of Information Recording Apparatus)

Firstly, with reference to FIG. 2, the basic structure of the information recording apparatus in the embodiment will be explained. FIG. 2 is a block diagram conceptually showing the basic structure of the information recording apparatus in the embodiment of the present invention.

As shown in FIG. 2, an information recording apparatus 1 is provided with an optical pickup 501, a spindle motor 502; a head amplifier 503; a driver/strategy circuit 504; a buffer 505; a DVD modulator 506; a data ECC (Error Correction Code) generator 507; a buffer 508; an interface 509; a sum generator 520; a demodulator 521; a pit data ECC circuit 522; a dropout detector 523; a push-pull generator 530; an LPF (Low Pass Filter) 531; a BPF (Band Pass Filter) 532; a HPF (High Pass Filter) 533; a TE (Tracking Error) detector 534; a wobble detector 535; an LPP (Land Pre Pit) detector 536; a FE (Focus Error) detector 537; a servo unit 540; a recording clock generator 541, an LPP data detector 542; a de-track detector 550; and a CPU 560.

The optical pickup 501 is one specific example of the “recording device” of the present invention. The optical pickup 501 is to perform the recording/reproduction with respect to the optical disc 100, and is provided with a semiconductor laser device, various lenses, an actuator and the like. More specifically, the optical pickup 501 irradiates the optical disc 100 with a light beam B, such as laser light, as writing light with a predetermined power, with it modulated. The optical pickup 501 is constructed to be displaced in the radial direction of the optical disc 100 or the like, in accordance with tracking servo, by a not-illustrated actuator, slider, or the like driven by the control of the servo unit 540. In addition, the optical pickup 501 is constructed to change focus of the light beam B in accordance with focus servo, to thereby focus-control it, under the control of the servo unit 540.

Moreover, the optical pickup 501 is provided with a not-illustrated four-division detection circuit. The four-division detection circuit divides the reflected light of the laser beam B into four areas A, B, C, and D shown in the upper part of FIG. 2, and outputs each signal corresponding to the quantity of light in respective one of the areas.

The spindle motor 502 is constructed to rotate the optical disc 100 at a predetermined speed under spindle servo from the servo unit 540 or the like.

The head amplifier 503 amplifies each output signal of the optical pickup 501 (i.e. the reflected light of the light beam B), and outputs a divisional read signal a corresponding to the area A, a divisional read signal b corresponding to the area B, a divisional read signal c corresponding to the area C, and a divisional read signal d corresponding to the area D.

The driver/strategy circuit 504 drives the semiconductor laser built in the optical pickup 501 in order to determine an optimum recording power. Then, the driver/strategy circuit 504 is constructed to drive the semiconductor laser of the optical pickup 501, by using the optimum value of the recording power, determined by the above-mentioned OPC process or by an actual data OPC process described later, at the time of data recording. At the time of data recording, the optimum recording power is modulated in accordance with the record data.

Incidentally, the OPC process is a process of detecting a proper recording power (i.e. a process of calibrating a recording laser power). More specifically, a short pit corresponding to a 3T pulse and a long pit corresponding to an 11T pulse, for example, are formed alternately with respective unrecorded sections having the same length, and this operation is performed with 16 different laser powers, for example. By this, the recording power is calculated to perform the recording so as to minimize an influence of asymmetry and so as to obtain the most excellent reproduction quality. Moreover, the “asymmetry” is a phenomenon in which the short pit gradually becomes longer, or the long pit gradually becomes shorter, in the length direction, at the mass production of the optical disc.

The buffer 505 is constructed to store therein the record data modulated by the DVD modulator 506, and output it to the driver/strategy circuit 504.

The DVD modulator 506 is constructed to perform DVD modulation on the record data, and output it to the buffer 505. As the DVD modulation, for example, EFM (Eight to Fourteen Modulation) may be performed.

The data ECC generator 507 appends a code for error correction, to the record data inputted from the interface 509. Specifically, the data ECC generator 507 appends an ECC code by each predetermined block unit (e.g. an ECC cluster unit), and outputs it to the DVD modulator 508.

The buffer 508 buffers the record data inputted from the interface 509 and outputs it to the data ECC generator 507, as occasion demands. Moreover, the buffer 508 buffers reproduction data outputted from the pit data ECC circuit 522 and outputs it to external output equipment through the interface 509, as occasion demands.

The interface 509 is constructed to receive an input of the record data or the like, from external input equipment, and output the reproduction data to the external output equipment.

Therefore, at the time of normal data recording, an ECC is appended on the data ECC generator 507 to a record signal inputted from the interface through the buffer, and then it is DVD-modulated on the DVD modulator 506. Then, by outputting it to the driver/strategy circuit 504 through the buffer 505, the optical pickup is driven by using the recording power with the optimum value, to thereby perform the recording on the optical disc.

The sum generation circuit 520 is provided with an addition circuit for adding the divisional read signals a, b, c, and d and for outputting a sum read signal SRF (i.e. one specific example of the “RF signal” of the present invention). Incidentally, the sum read signal SRF is a signal which represents the length of the record mark.

The demodulator 521 reproduces pit data on the basis of the sum read signal SRF. More specifically, the demodulator 521 demodulates the reproduced pit data by using a predetermined table, with a synchronization signal for reproduction as a reference position, to thereby generate the reproduction data. For example, if EFM modulation is adopted as a modulating method, a process of converting 14-bit pit data to 8-bit reproduction data is performed. Then, a descramble process is performed in which the order of the reproduction data is rearranged in accordance with a predetermined rule, and the processed reproduction data is outputted.

The pit data ECC circuit 522 performs an error correction process and an interpolation process or the like, on the reproduction data generated on the demodulator 521. Then, the reproduction data is outputted to the interface 509 through the buffer 508, and is reproduced on the external output equipment, such as a speaker and a display.

The dropout detector 523 is constructed to detect whether or not the sum read signal SRF is outputted from the sum generator 520. Then, the detection result, i.e. the indication that the sum read signal SRF is outputted or not outputted, is outputted to the de-track detector 550.

The push-pull signal generator 530 calculates (a+d)−(b+c) by using a division read signal and generates a push-pull signal. The component (a+d) corresponds to the areas A and D which are on the left side with respect to the reading direction, while the component (b+c) corresponds to the areas B and C which are on the right side with respect to the reading direction. The value of the push-pull signal indicates a relative position relationship between the light beam B and the pit.

The LPF 531 cuts off a signal component in a high frequency zone, out of the push-pull signal outputted from the push-pull generator 530, and outputs a signal component in a low frequency zone to the TE detector 534. Namely, here, a tracking error signal component is extracted and outputted to the TE detector 534.

The BPF 532 extracts a signal component related to a wobble signal, out of the push-pull signal outputted from the push-pull generator 530, and outputs it to the wobble detector 635.

The HPF 533 cuts off a signal component in the low frequency zone, out of the push-pull signal outputted from the push-pull generator 530, and outputs a signal component in the high frequency zone to the LPP detector 536. Namely, here, an LPP signal is extracted and outputted to the LPP detector 536.

The TE detector 534 detects a tracking error from the tracking error signal component, out of the push-pull signal inputted through the LPF 531. Then, it outputs the tracking error signal to the servo unit 540. Moreover, the tracking error signal is also outputted to the de-track detector 550.

The wobble detector 535 detects a wobble signal component, out of the push-pull signal inputted through BPF 532, and also detects relative position information based on a slot unit corresponding to a length which is a natural number multiple of one cycle of the wobble signal, for example, on the basis of the cycle of the wobble signal. Then, the wobble detector 535 is constructed to output the relative position information to the recording clock generator 541. Moreover, the relative position information is also outputted to the servo unit 540 and the LPP data detector 542.

The LPP detector 536 detects an LPP signal component, out of the push-pull signal inputted through HPF 533, and detects pre-format address information expressed by the LPP (Land Pre-Pit), on the basis of the LPP signal. Then, the LPP detector 536 is constructed to output the pre-format address information to the recording clock generator 541. Moreover, the pre-format address information is also outputted to the servo unit 540 and the LPP data detector 542.

The FE detector 537 detects a focus error on the basis of the distribution of signal intensity of the four-division detector, from the sum read signal SRF outputted by the sum generator 520. Then, it outputs a focus error signal to the servo unit 540. Moreover, the focus error signal is also outputted to the de-track detector 550.

The servo unit 540 displaces the objective lens of the optical pickup 501, on the basis of the tracking error signal, the focus error signal, the wobble signal, the LPP signal, or the like, obtained by processing the light receiving result of the optical pickup 501. By this, the servo unit 540 performs various servo processes, such as tracking control, focus control, and spindle control.

The recording clock generator 541 generates and outputs a timing signal indicating a reference clock to perform the data recording, on the basis of the cycle (or the relative position information) of the wobble signal outputted from the wobble detector 535 and the pre-format address information outputted from the LPP detector 536. Thus, regardless of whether or not a recording start position at the time of data recording is started from the management unit of the pre-format address information, it is possible to specify the recording start position.

The LPP data detector 542 is constructed to obtain various management information or the like necessary at the time of recording, from the LPP signal outputted from the LPP detector 536. For example, as described later, it is possible to obtain a recommended recording power, a recommended strategy or the like, which are recorded by the LPP.

The de-track detector 550 is constructed to detect whether or not de-track has occurred while the data is recorded onto the optical disc 100. More specifically, into the de-track detector 550, the tracking error signal is inputted by the TE detector 534, and the focus error signal is inputted by the FE detector 537. It can be monitored whether or not these signals are larger than a predetermined value. Moreover, the de-track detector 550 is constructed to monitor whether or not there is an input of the sum read signal SRF outputted from the sum generator 520, as the output of the dropout detector 523. Moreover, the de-track detector 550 is constructed to compare the timing of recording performed by the optical pickup 501 (or the cycle of the wobble signal) with the timing signal generated by the recording clock generator 541. Moreover, the de-track detector 550 is constructed to monitor the pre-format address information (or a physical address value) in the position where the optical pickup 501 performs the recording. In this case, the de-track detector 550 is preferably constructed to obtain the pre-format address information from the LPP detector 536, via a not-illustrated signal line. Moreover, if the optical disc 100 is an optical disc having multiple recording layers, the de-track detector 550 is preferably constructed to detect a layer flag for identifying each layer.

Then, the de-track detector 550 detects whether or not de-track has occurred on the optical disc 100 during the recording, on the basis of the monitored signals and the flag or the like. If at least one of the signals shows an abnormal value, it can be judged that de-track has occurred. Alternatively, if a combination of two or more of the signals show abnormal values, it can be judged that de-track has occurred.

In addition, the de-track detector 550 may be constructed to detect a position where the de-track has occurred on the optical disc 100 (e.g. a physical address value on the optical disc 100) and a time length in which incorrect recording is performed on the optical disc 100 after the occurrence of the de-track.

The CPU 560 controls the entire information recording apparatus 1, by giving an instruction to each device, i.e. by outputting a system command to each device, such as the driver/strategy circuit 504, the servo unit 540, the LPP data detector 542 and the de-track detector 550. Moreover, if the occurrence of the de-track is inputted by the de-track detector 550, it is preferably constructed such that an instruction to stop the subsequent data recording is outputted to the optical pickup 501 or the like. Typically, software for operating the CPU 560 is stored in an internal or external memory.

The OPC pattern generator 570 is one specific example of the “calibrating device” of the present invention. The OPC pattern generator 570 is constructed to output a signal indicating the OPC pattern, to the optical pickup 501, on the basis of the timing signal from the recording clock generator 541, when the OPC pattern is recorded in the OPC process. Moreover, it may be constructed such that the driver/strategy circuit 504 is instructed to record the signal indicating the OPC pattern, with the recording power sequentially changed to a lower power.

The envelope detector 571 is constructed to detect the peak value and the bottom value of envelope detection of the SRF signal, in order to determine the optical value, under the control of the CPU 560, at the time of reproduction of the OPC pattern in the OPC process. Then, it is constructed such that asymmetry described later can be detected from the peak value and the bottom value. Incidentally, the “asymmetry” is a phenomenon in which the short pit gradually becomes longer, or the long pit gradually becomes shorter, in the length direction, at the mass production of the optical disc. In the embodiment, the degree of the influence of the asymmetry is quantitatively expressed by an “asymmetry value” described later.

Moreover, jitter indicating a wobbling on the time axis can be detected by the envelope detection. The envelope detector 571 may be constructed to include an A/D (Analog/Digital) converter or the like, for example. In addition, even when actual data OPC is performed, it is possible to detect the asymmetry and the jitter in the same manner.

Particularly in the embodiment, in order to perform the “actual data OP C” as explained later, one example of the “optimizing device” of the present invention is constructed from the CPU 560 and the envelope detector 571 or the like, and one example of the “adjusting device” of the present invention is constructed from the CPU 560 and the driver/strategy circuit 504 or the like.

Incidentally, the information recording apparatus in the embodiment explained with reference to FIG. 2 is also an embodiment of an information recording/reproducing apparatus. Namely, it can reproduce the record information through the head amplifier 503, the sum generator 520, the demodulator 521, and the pit data ECC circuit 522. This embodiment includes the function of an information reproducing device or the function of the information recording/reproducing apparatus.

(Operation Principle of Information Recording Apparatus)

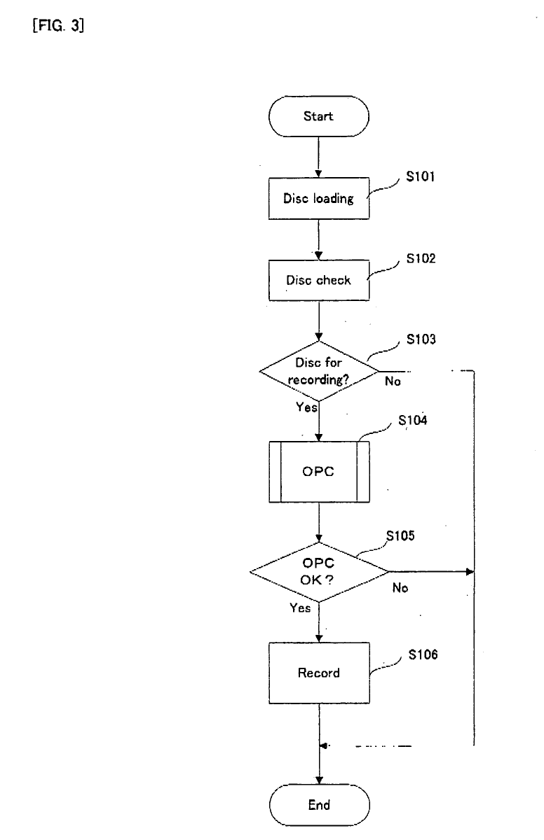

Next, with reference to FIG. 3 to FIG. 13, the recording operation of the information recording apparatus 1 will be explained.

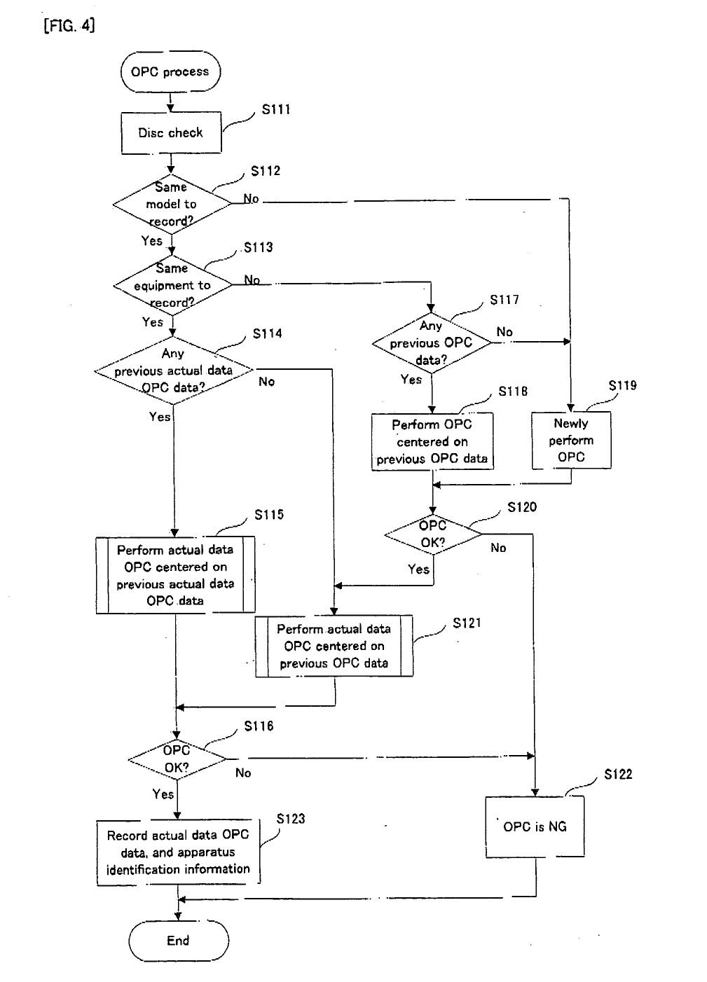

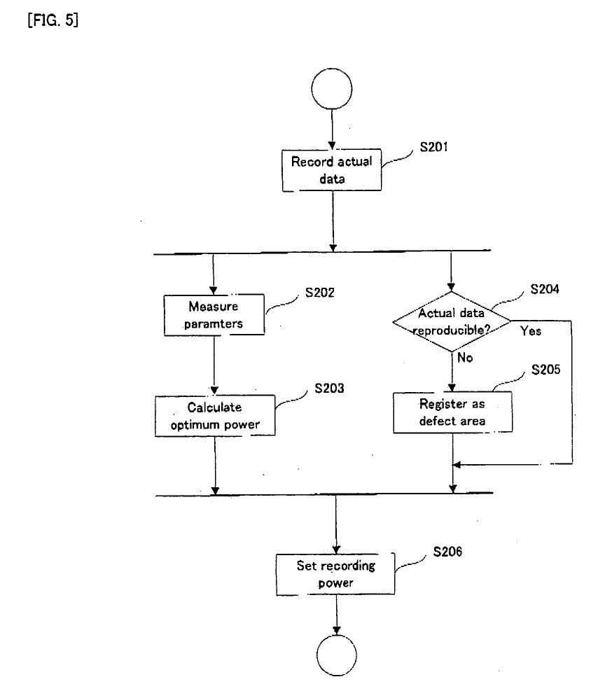

Firstly, with reference to FIG. 3 to FIG. 5, a flow of the recording operation will be conceptually explained. FIG. 3 is a flowchart showing a flow of the entire recording operation of the information recording apparatus in the embodiment. FIG. 4 is a flowchart showing a flow of an entire OPC operation of the information recording apparatus in the embodiment. FIG. 5 is a flowchart showing a flow of an actual data OPC operation of the information recording apparatus in the embodiment.

Incidentally, the “actual data OPC” in the embodiment indicates that the OPC is performed by using the data used when the information recording apparatus 1 actually writes the information onto the optical disc 100. More specifically, the “actual data OPC” indicates the OPC which is performed by recording the data, which is obtained by appending ECC data and DVD-modulating to the data obtained by arbitrarily combining “0” and “1” for example, is recorded while changing the recording power sequentially step by step. In contrast, the so-called normal “OPC” indicates the calibration performed by recording the OPC data having the “3T” and “11T” pit length sections (i.e. the OPC pattern), in the case of a DVD, for example, while the recording power is changed. In either case, by reproducing the recorded data, the recording power is obtained to perform the recording so as to minimize the influence of asymmetry and so as to obtain the most excellent reproduction quality.

As shown in FIG. 3, firstly, the optical disc 100 is loaded (step S101). Then, control information or the like recorded in the lead-in area 104 or the like is read, and disc check is performed (step S102). Then, on the basis of the result of the disc check, it is judged whether or not the loaded optical disc 100 is a disc for recording (e.g. a DVD-R/RW, a DVD-RAM, etc.) (step S103).

As a result of the judgment, if it is judged that the loaded optical disc 100 is not the disc for recording (e.g. it is a DVD-ROM or the like) (the step S103. No), the recording operation is ended because the recording operation including the OPC cannot be performed on the optical disc 100.

On the other hand, if it is judged that the loaded optical disc 100 is the disc for recording (the step S103: Yes), then, the OPC process is performed (step S104). The OPC process will be described in detail later (refer to FIG. 4 and FIG. 5). Then, it is judged whether or not the OPC process is normally performed (i.e. whether or not a preferable optimum recording power can be calculated) (step S105). Here, it may be judged whether or not the OPC in the step S104 is normally performed on a program operated on the CPU 560 on the basis an OPC flag indicating whether or not the result of the OPC is normal as described later, for example.

As a result of the judgment, if it is judged that the OPC is normally performed (the step S105: Yes), the recording operation is performed with the laser power obtained from the result of the OPC (step S106). On the other hand, if it is judged that the OPC is not normally performed (the step S105: No), the recording operation is ended because the normal recording operation cannot be performed.

Next, with reference to FIG. 4, the OPC operation in the step S104 will be explained.

As shown in FIG. 4, the control information or the like recorded in the lead-in area 104 or the like is read, and disc check is performed (step S111). Then, on the basis of the result of the disc check, it is judged whether or not the information recording apparatus 1 on which the optical disc 100 is loaded is the same model as that of an apparatus on which the optical disc 100 is previously loaded (step S112). The “model” herein indicates the model number or part number or the like of the information recording apparatus 1, and more specifically, it is identified by the model number, such as a DVR-77H and a DVR-99H. Then, information indicating the “model” is recorded onto the optical disc 100, by the information recording apparatus 1 which has performed the OPC process, as described later.

As a result of the judgment, if it is judged that it is the same model (the step S112: Yes), moreover, it is judged whether or not the information recording apparatus 1 is the same equipment as the apparatus on which the optical disc 100 is previously loaded (step S113). The “equipment” herein indicates the same information recording apparatus, and is identified by an apparatus-specific number (apparatus-identification number) or the like. Then, information indicating the “equipment” is recorded onto the optical disc 100, by the information recording apparatus 1 which has performed the OPC process, as described later.

As a result of the judgment, if it is judged that it is the same equipment (the step S113: Yes), then, it is judged whether or not previous actual data OPC data (i.e. one specific example of the “optimum value” of the present invention) is recorded, on the apparatus (step S114). For example, it is judged whether or not the optimum value obtained by the actual data OPC previously performed is recorded on the optical disc 100, as the actual data OPC data.

As a result of the judgment, if it is judged that the previous actual data. OPC data is recorded (the step S114: Yes), the actual data OPC is performed by using the previous actual data OPC data (step S116). Specifically, the actual data OPC is performed centered on the optimum value recorded as the previous actual data OPC data, for example. The operation of the actual data OPC will be described in detail later (refer to FIG. 5, etc.).

Then, it is judged whether or not a more proper optimum value can be obtained by the actual data OPC (step S116). Specifically, it is judged whether or not a recording power having a target asymmetry value (i.e. a target β value) can be obtained.

As a result of the judgment, if it is judged that the proper optimum value can be obtained (the step S116: Yes), the OPC process is ended. Then, the obtained optimum value (i.e. the actual data OPC data) is recorded onto the optical disc 100, and moreover, apparatus identification information capable of identifying the information recording apparatus 1 which has performed the actual data OPC (e.g. the specific number and the model number or the like, identifying the above-mentioned model and equipment) is also recorded onto the optical disc 100 (step S123). In addition, the OPC flag indicating whether or not the result of the OPC is normal may be overwritten as “OK”, in the program operated on the CPU 560, for example.

On the other hand, if it is judged that the proper optimum value cannot be obtained (the step S116: No), it is judged that the OPC has not been properly performed (step S122). Here, the OPC flag indicating whether or not the result of the OPC is normal may be overwritten as “NG”, in the program operated on the CPU 560, for example.

On the other hand, in the step S114, if it is judged that the previous actual data OPC data is not recorded (the step S114: No), the actual data OPC is performed by using the OPC data obtained by the normal OPC previously performed (which is one specific example of the “calibration value” of the present invention and which is the value of the recording power obtained by the OPC) (step S121). The process in the step 121 can be performed, because the previous OPC data, which is based on the OPC performed by the information recording apparatus 1 on which the optical disc 100 is loaded, is recorded on the optical disc 100 as long as it is the same model and the same equipment. After that, as described above, it is judged whether or not the more proper optimum value can be obtained by the actual data OPC in the step S121 (the step S116).

On the other hand, as a result of the judgment in the step S113, if it is judged that it is not the same equipment (the step S113: No), it is judged whether or not there is the previous OPC data which is the OPC data obtained by the normal OPC previously performed (step S117). Specifically, it is judged whether or not the value of the recording power obtained by the previous OPC is recorded on the optical disc 100.

As a result of the judgment, if it is judged that there is the previous OPC data (the step S117 Yes), the normal OPC is performed again centered on the previous OPC data (step S118). The OPC performed centered on the previous OPC data will be also described in detail later (refer to FIG. 6 etc.).

On the other hand, if it is judged that there is no previous OPC data (the step S117; No), the OPC is newly performed (step S119). In this regard, the OPC data in the “3T” and “11T” patterns is recorded by changing the recording power in 16 steps, for example, in the OPC area described later (refer to FIG. 6, etc.), and the recording power of the optical pickup 501 is adjusted by the driver/strategy circuit 504, for example, so as to minimize the asymmetry of the “3T” pattern and the “11T” pattern in the reproduction signal of the recorded OPC data. The OPC pattern is outputted by the OPC pattern generator 570, and the asymmetry is detected by the envelope detector 571. Then, for example, the CPU 560 determines the recording power which minimizes the asymmetry.

Moreover, when the OPC is performed, disc information recorded by the LPP formed on the optical disc 100 may be read, and the recommended recording power and the recommended strategy or the like may be read in advance. At this time, the recording power in the OPC in the step S102 preferably has a constant range of power values, based on the recommended recording power.

After that, it is judged whether or not the value of the proper recording power can be obtained, by the OPC performed in the step S118 or step S119 (step S120). This operation is the same as the above-mentioned judgment operation in the actual data OPC (i.e. the step S116).

As a result of the judgment, if it is judged that the value of the proper recording power can be obtained (the step S120. Yes), the actual data OPC is performed centered on the previous OPC data (which is the OPC data obtained in the step S118 or step S119 in this case) (step S121). On the other hand, if it is judged that the value of the proper recording power cannot be obtained (the step S120: No), the operational flow goes to the step S122, and the above-mentioned various operations are performed.

On the other hand, as a result of the judgment in the step S112, if it is judged that it is not the same model (the step S112: No), the OPC is newly performed as described above (the step S119). After that, as described above, it is judged whether or not the value of the proper recording power can be obtained in the step S120, and the actual data OPC is performed.

As described above, since the OPC can be performed by using the actually recorded data, it is possible to obtain the optimum value which meets the actual recording conditions.

Incidentally, in the above-mentioned embodiment, the actual data OPC is performed when the optical disc 100 is loaded; however, performing the actual data OPC is not limited to this. For example, even during the recording operation, the actual data OPC may be performed in each predetermined period. Moreover, on the optical disc 100, if a position where the recording is actually performed is greatly changed, the actual data OPC may be performed. For example, the actual data OPC may be performed if the recording position is displaced from the inner to the outer circumferential side or if a layer to record is changed in the case of an optical disc having a plurality of recording layers, or the like. Alternatively, the actual data OPC may be performed if there is an instruction from a user of the information recording apparatus 1, which is inputted from a remote controller and an operation button or the like.

Next, with reference to FIG. 5, the operation of the actual data OPC in the step S115 or step S121 in FIG. 4 will be explained in more detail.

As shown in FIG. 5, firstly, the actual data is recorded into a predetermined position in the data recording area of the optical disc 100 (step S201). herein this case, original data which is a data-array of continuous “0”, for example, is inputted to the data ECC generator 507, by which the ECC data is appended, and after that, it is further inputted to the DVD modulator 506, by which the DVD modulation (e.g. EFM modulation) is performed on the data. By this, the actual data which is recorded in step S201 is generated. Such DVD-modulated data is recorded onto the optical disc 100, as the actual data to obtain the optimum value.

Moreover, at this time, the actual data is recorded with the recording power in each of several stages (e.g. 2 steps, 4 steps, 8 steps, 16 steps, etc.). The recording power is set on the basis of the optimum value indicated by the above-mentioned previous OPC data or actual data OPC data. By this, if the actual data OPC is performed, it is possible to refer to the recording power in the OPC, relatively easily, in determining the recording power with which the actual data is recorded.

Now, the recording power related to the actual data is explained more specifically, with reference to FIG. 6. FIG. 6 is a graph showing a correlation between a recording power changed sequentially step by step and an asymmetry value.

For example, according to the normal OPC (which, in this case, is the OPC in which the recording power is not changed centered on a certain recording power, different from the embodiment), the recording power is adjusted stepwise, in a relatively large recording power range, such as 16 steps, for example. Specifically, the recording power is changed sequentially step by step, in a range from a recording power A to a recording power B, as shown in FIG. 6. However, in the embodiment, the recording power can be changed stepwise in a narrower range, centered on the value of the recording power already obtained by the normal OPC (i.e. calibration value) or the optical value obtained by the actual data OPC. If the calibration value or the optimum value is S, the recording power is changed sequentially step by step, in a range from a recording power a to a recording power b, as shown in FIG. 6. Namely, the recording power is changed in a narrower range than the range of the recording power changed in the normal OPC. This is because even if the optimum value is changed due to a change in recording features or the like of the optical disc 100, the value can be estimated to be close to the proper recording power S which is already obtained by the normal OPC previously performed or the actual data OPC. By this, in the actual data OPC, it is possible to obtain the optimum value, by changing the recording power sequentially step by step, in the relatively narrow recording power range. Therefore, as compared to the normal OPC, it is possible to obtain the optimum value, relatively easily and more efficiently.

Even with regard to the OPC in the step S118 in FIG. 4, the recording power is changed sequentially step by step, in the relatively narrow recording power range, centered on the lowest value indicated by the previous OPC data, as shown in FIG. 6.

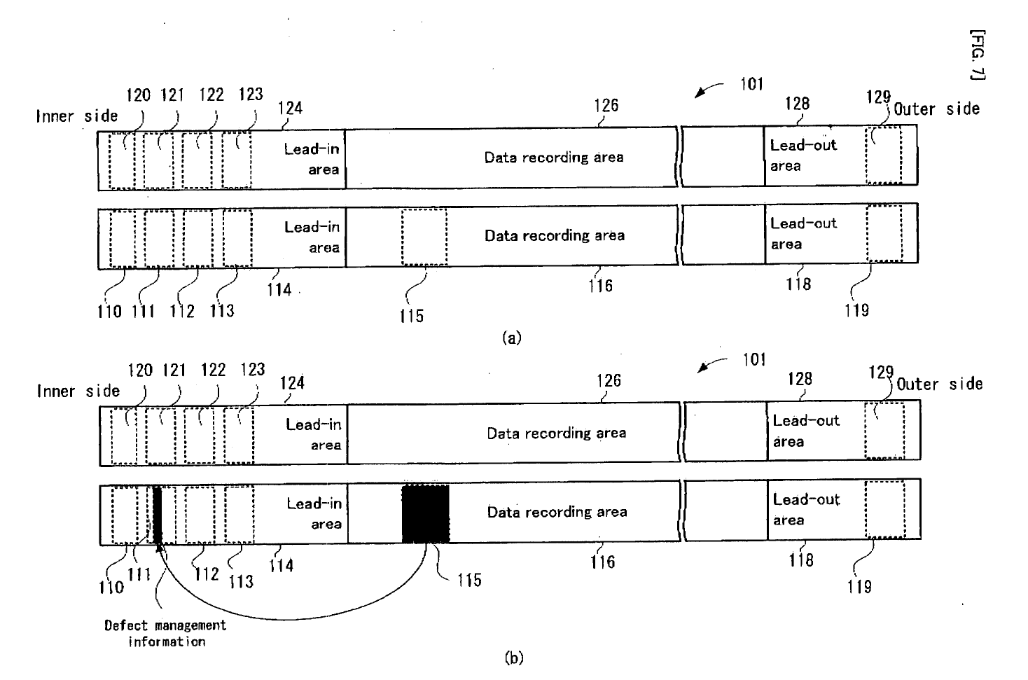

Incidentally, the actual data may be treated as a file, on the data recording area. Namely, the recorded actual data area may be registered in a file system described later (refer to FIG. 7, etc.), as one file data. Moreover, the time length with which the actual data OPC is performed and the position to which the actual data OPC is performed may be also recorded onto the optical disc 100.

In FIG. 5 again, then, various parameters are measured by reproducing the recorded actual data (step S202). For example, the jitter value of the reproduction signal, the asymmetry value or the error rate or the like is calculated.

For example, in the case of the asymmetry value, it is measured from the peak value and the bottom value of envelope detection which is detected by inputting the sum read signal SRF, which is obtained by reproducing the actual data, to the envelope detector 571. Moreover, in the case of the jitter value, a wobbling of an envelope waveform on the time axis is measured from the output of the envelope detector 571 in the same manner. Moreover, in the case of the error rate, it may be measured by calculating the incidence of errors when error correction is performed, on the pit data ECC circuit 522 to which the sum read signal SRF modulated on the demodulator 521 is inputted, for example.

Then, on the basis of the parameters, the optimum value is obtained under the control of the CPU 560 (step S203): Here, the value of the recording power which allows the jitter value to be minimal, the asymmetry value to be minimal and/or the error rate to be minimal is to be the optimum value. Therefore, the CPU 560 obtains the optimum value which satisfies such a condition, on the basis of the correlation shown in FIG. 6, or the like, for example.

Nevertheless, in the association among these parameters, the value of the recording power which preferentially minimizes any one of the parameters may be set to the optimum value. For example, the value of the recording power which does not minimize the jitter value but minimizes the asymmetry value may be set to the optimum value. Moreover, the parameters used in obtaining the optimum value are not limited to these, and other various reproduction feature parameters or the like may be also considered.

On the other hand, simultaneously with or after the operation of obtaining the optimum value by reproducing the actual data described above, it is judged whether or not reproduction can be performed in the portion where the actual data is recorded, under the control of the CPU 560, which is one specific example of the “judging device” of the present invention (step S204). For example, it is judged whether or not the original data, which is a data-array of continuous “0”, can be reproduced by performing the reproduction in the portion where the actual data is recorded. The judgment may be performed by the CPU 560, for example.

Incidentally, even if the actual data is not actually reproduced, the judgment of whether or not reproduction can be performed may be performed on the basis of the extent of the recording power when the actual data is recorded. More specifically, if the recording power when the actual data is recorded is relatively larger than the recording power generally used when content data is recorded, it may be judged that reproduction cannot be performed. This is the judgment based on the general matter that the recording surface of the optical disc 100 is damaged and the reproduction cannot be performed on its recording surface due to too large recording power By this, it is possible to perform the judgment of whether or not reproduction can be performed, relatively easily, without actually reproducing the actual data.

As a result of the judgment, if it is judged that reproduction can be performed (the step S204: Yes), the operational flow goes to a step S206. On the other hand, if it is judged that reproduction cannot be performed (the step S204: No), the area where the actual data is recorded is registered as a defect area, in order to set the area where the actual data is recorded as an unusable area, under the control of the CPU 560, which is one specific example of the “controlling device” of the present invention (step S205). Now, the defect area is explained with reference to FIG. 7. FIG. 7 are data structure diagrams conceptually showing the data structure of an optical disc 101 on which defect management can be performed.

As shown in FIG. 7(a), the optical disc 101 is an optical disc having two recording layers. The lower layer in FIG. 7(a) is provided with: a lead-in area 114; a data recording area 116; and a lead-out area 118. The lead-in area 114 is further provided with: an OPC area 110; a defect management area 111; a control information area 112, and has a file system 113 recorded. Moreover, the upper layer in FIG. 7(a) is provided with: a lead-in area 124; a data recording area 126; and a lead-out area 128. The lead-in area 124 is further provided with: an OPC area 120; a defect management area 121; a control information area 122, and has a file system 123 recorded.

The OPC area 110 (120) is an area used for the process of detecting a proper recording power (i.e. the process of calibrating a recording laser power), as described above. For example, after completion of the test writing of the OPC pattern, the test-written OPC pattern is reproduced, and the reproduced OPC pattern is sequentially sampled, to thereby obtain the optimum recording power. Moreover, the value of the proper recording power obtained by the OPC may be recorded.

In the defect management area 111 (121), defect management information which is data for managing a defect which has occurred on the optical disc 101 is recorded. In the defect management information, there are recorded a position (or its address) where a defect has occurred in the data recording area 116 (126), its size and the address value of a destination to which an evacuation data which is data to be originally recorded or already recorded in the position where the defect has occurred is evacuated.

The control information area 112 (122) is an area to record therein the control information. The control information is information for controlling the recording and the reading with respect to the data recording area 116, and it is, for example, information indicating the attribute and the type of the optical disc 101, information for address management of the data, information for controlling the recording operation and the reading operation of the information recording apparatus 1, such as a disc drive, or the like.

In the file system 113 (123), there is recorded various management information necessary for the recording operation and the reproduction operation performed on the optical disc 101. For example, it includes area structure data of the entire optical disc 101 (e.g. a distribution map about a data recording area where the data is already recorded and an data recording area where the data is not recorded, etc.), information for specifying a usable area, or the like.

Moreover, the lead-out area 118 is provided with a spare area 119, and the lead-out area 128 is provided with a spare area 129. The spare area 119 (129) is an area to which the evacuation data is evacuated. Then, the address value or the like on the spare area 119 (129) of the evacuation data which is evacuated to the spare area 119 (129) is recorded into the above-mentioned defect management information.

Incidentally, the arrangement of these areas is merely one example, and it is not limited to this order. It is obvious that it is possible to perform the recording operation of the information recording apparatus 1 in the embodiment, even if each area is located in an arbitrary place.

Then, at this time, it is assumed that the actual data is recorded into a predetermined area 115 on the data recording area 116, to thereby perform the actual data OPC. Then, as shown in FIG. 7(b), the address value and the size of the area 115 are specified, and the defect management information including the address value and the size is recorded into the defect management area 111.

Moreover, as shown in FIG. 7, in the case of the optical disc 101 having two recording layers, for example, it is predicted that the optimum value related to the layer on the rear side viewed from the optical pickup 501 varies depending on the condition (e.g. recorded condition or unrecorded condition, etc.) of the front layer located between the optical pickup 501 and the rear layer. Therefore, when the actual data OPC is performed in the rear layer, it is preferable to consider the condition of the front layer. For example, if the recording is performed into the rear layer under the condition that the front layer is recorded, it is preferable that a portion in the front layer corresponding to the portion where the actual data is recorded is in a recorded condition, when the actual data OPC is performed in the rear layer. Moreover, if the recording is performed into the rear layer under the condition that the front layer is unrecorded, it is preferable that a portion in the front layer corresponding to the portion where the actual data is recorded is in an unrecorded condition, when the actual data OPC is performed in the rear layer.

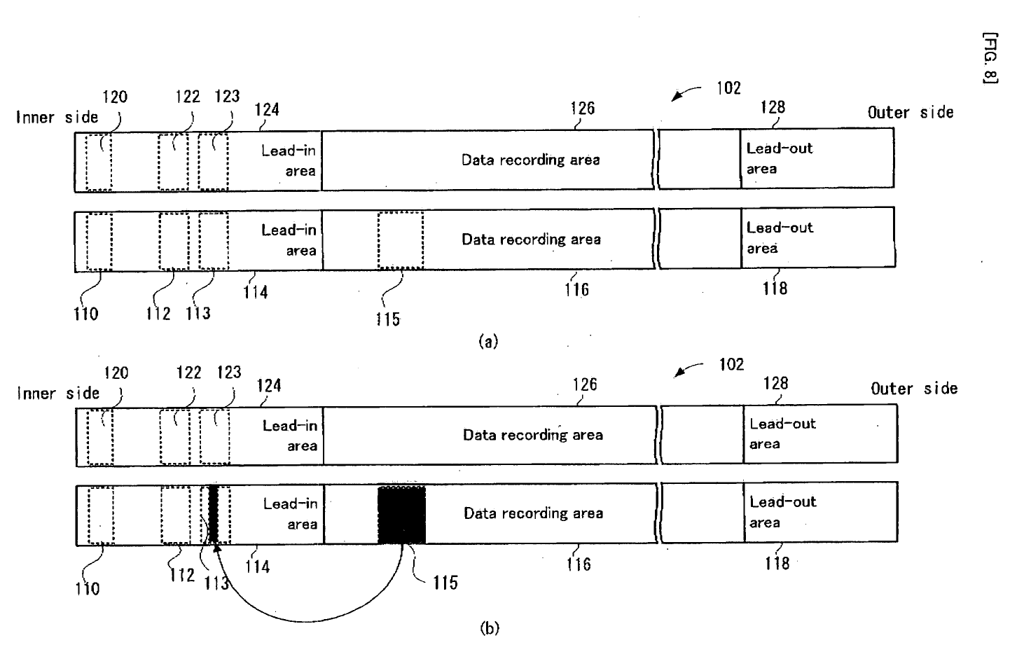

Incidentally, as shown in FIG. 8(a) and FIG. 8(b), the area where the actual data is recorded may be registered as an unallocated area, in order to set the area where the actual data is recorded as an unusable area, by using the file system 113 (123). For example, as shown in FIG. 8(a), in the case of an optical disc 102 having no defect management area 111 (122) nor spare area 119 (129), the area where the actual data is recorded cannot be registered as the defect area, as shown in FIG. 7. Therefore, in this case, as shown in FIG. 8(b), in the file system 113, if the area is registered as the unallocated area, then, it is possible to prevent the incorrect reproduction of the area 115 where the actual data is recorded, at the time of reproduction of the optical disc 102.

In FIG. 5 again, after the operation in the step S205 is ended, the operational flow goes to the step S206. Then, under the control of the CPU 560, the recording power of the optical pickup 501 is set by the operation of the driver/strategy circuit 504, which is one specific example of the “adjusting device” of the present invention. Here, the recording power is preferably set to the optimum value obtained in the step S203.

Consequently, since the recording power is adjusted by using the actual data, it is possible to adjust the recording power which meets the actual recording conditions. In particular, in addition to the calibration of the recording power performed in advance (i.e. the OPC process in the step S102 in FIG. 3), the recording power is further adjusted by using the actual data. So, the data can be recorded with the more preferable optimum value.

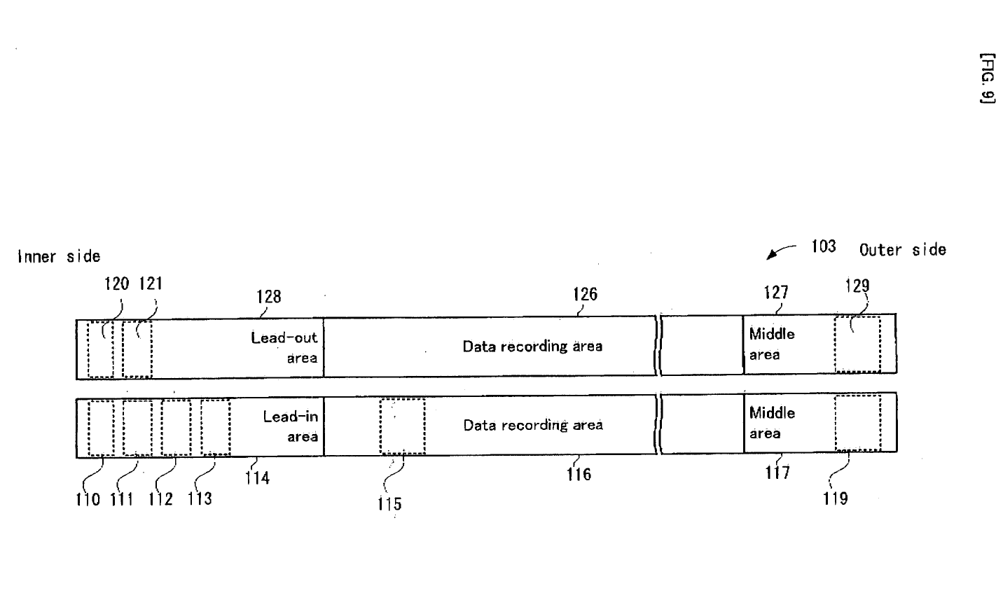

Incidentally, in the above-mentioned FIG. 7 and FIG. 8, the optical disc 101 or 102 of a parallel track path type is explained as an example. However, it is not limited to this, and the actual data OPC can be performed even on an optical disc 103 of an opposite track path type, as shown in FIG. 9, for example. On the optical disc 103 of an opposite track path type shown in FIG. 9, the data is recorded from the left of the lower layer in FIG. 9, and after the recording is ended in the data recording area 116 of the lower layer, for example, the data is recorded from the right of the upper layer in FIG. 9. Namely, it is an optical disc on which recording directions are opposite between the upper layer and the lower layer. The optical disc 103 of an opposite track path type is provided with: a lead-in area 114; a data recording area 116; and a middle area 117 in the lower layer, and the middle area 117 has a spare area 119. Moreover, in the upper layer, it is provided with a lead-out area 128; a data recording area 126; a middle area 127, and the middle area 127 has a spare area 129, and the lead-out area 128 has an OPC area 120 and a defect management area 121. In contrast, the optical disc 101 (102) of a parallel track path type is an optical disc on which recording directions are the same between the upper layer and the lower layer.

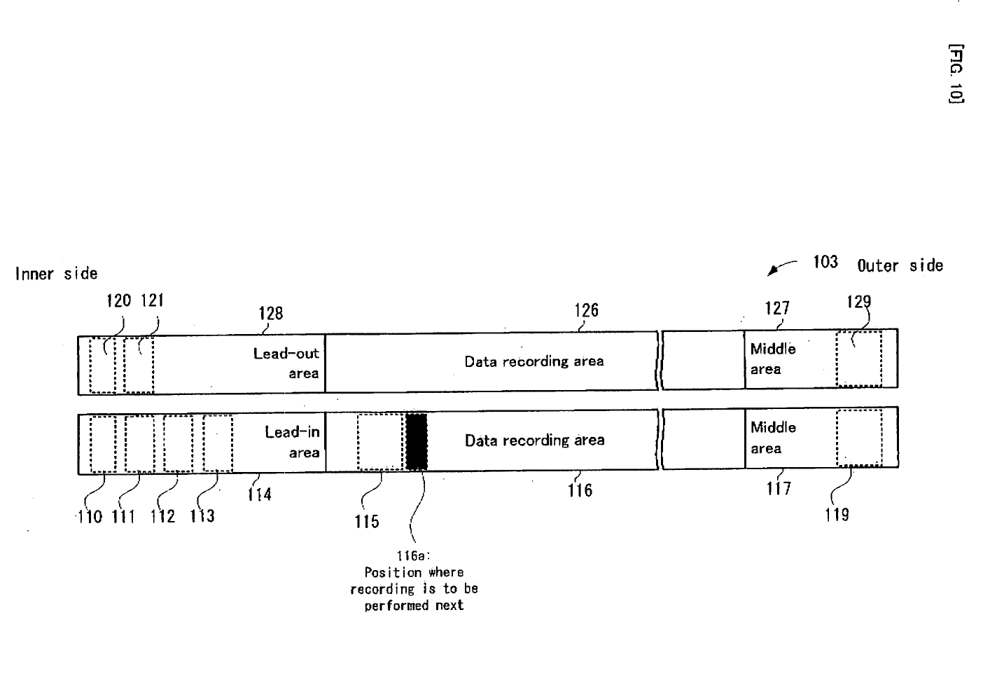

Moreover, the position where the actual data is recorded may be an arbitrary position as long as it is in the data recording area 116 (126); however, more preferably, it is preferably near the position where the content data is recorded after the actual data OPC process is performed. Namely, as shown in FIG. 10, if the position where the content data is recorded later (i.e. next) is an area 116a, the actual data is preferably recorded into an area 115 adjacent to the area 116a. By this, it is possible to obtain the preferable optimum value in response to the features of the area 116a where the content data is recorded, and there is a great advantage that an extremely preferable recording operation can be performed.

However, the area 115 is not necessarily adjacent to the area 116a. As long as it is an area in the data recording area 116 having the same or substantially the same recording features or the like as those of the area 116a, the actual data can be recorded into the area, to thereby obtain the more preferable optimum value.

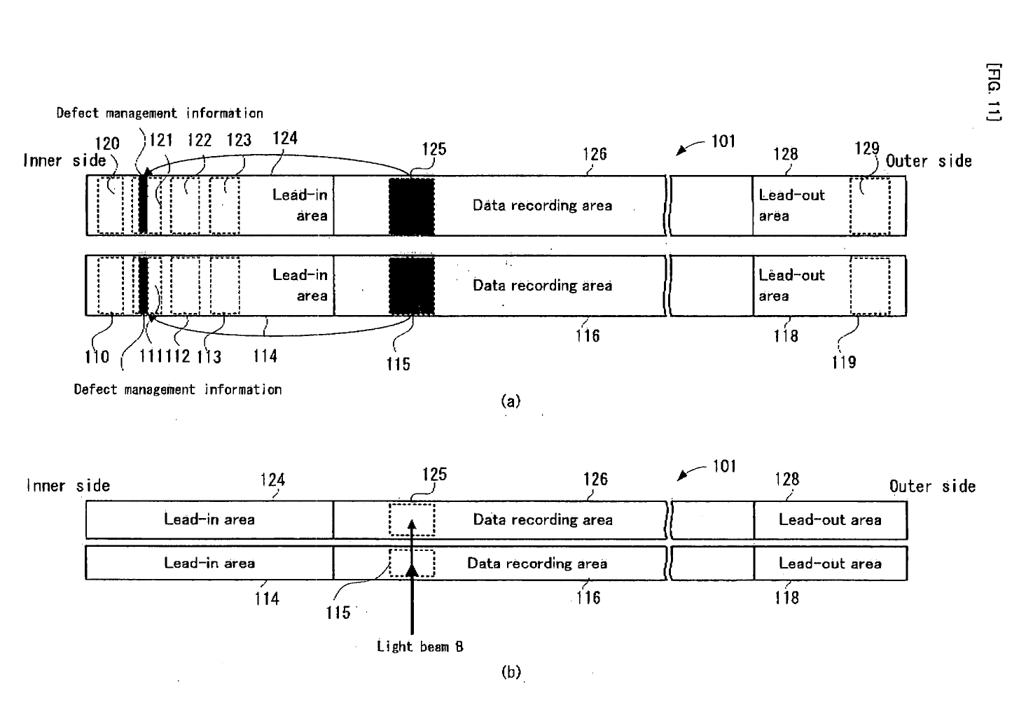

Moreover, as shown in FIG. 11(a), if the actual data is recorded into the area 115 in the lower layer, for example, the area 115 may be registered as the defect area. In addition to this registration, a corresponding area 125 in the upper layer (e.g. an area having the same track number as that of the area 115) may be also registered as the defect area.

More specifically, as shown in FIG. 11(b), it is assumed that the light beam B from the optical pickup 501 is irradiated from the lower layer side. At this time, it is also considered that not only the area 115 in the lower layer but also the area 125 in the upper layer is irradiated with the light beam B through the lower layer. Then, it is predicted that the irradiation of the light beam B has some influence on the area 125. Therefore, by registering the area 125 as the defect area, it is possible to make the recording operation more highly reliable, and it is also possible to effectively prevent a reproduction error or the like in the reproduction operation.

Here, the area 125 is not limited to an area having the same size (or the same track number) as that of the area 115. Namely, in the case of the disc-shaped optical disc shown in FIG. 1, for example, it is also considered that the area in the upper layer and the area in the lower layer, which are related to the same track number, are not aligned linearly with respect to the light beam B, due to a shift (i.e. eccentricity) of the respective center holes 102 in upper layer and the lower layer. Therefore, in this case, registering not only the area in the upper layer having the same track number as that of the area 115, but also a nearby area, as the defect area, is preferable from the point of view of reliable recording and reproduction. Moreover, since the light beam B converges to the area 115 from the optical pickup 501, it is considered that the upper layer is irradiated with the light beam B, more than the extent that the area 115 is irradiated. Therefore, from that viewpoint, it is preferable to register not only the area in the upper layer having the same track number as that of the area 115, but also the nearby area, as the defect area, for example.

(Another Operation Example)

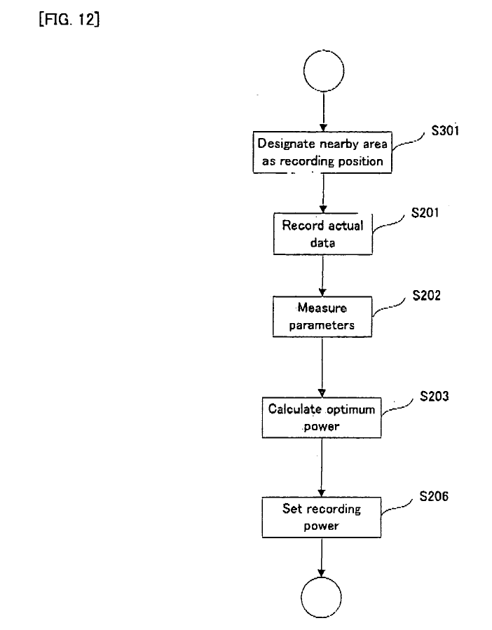

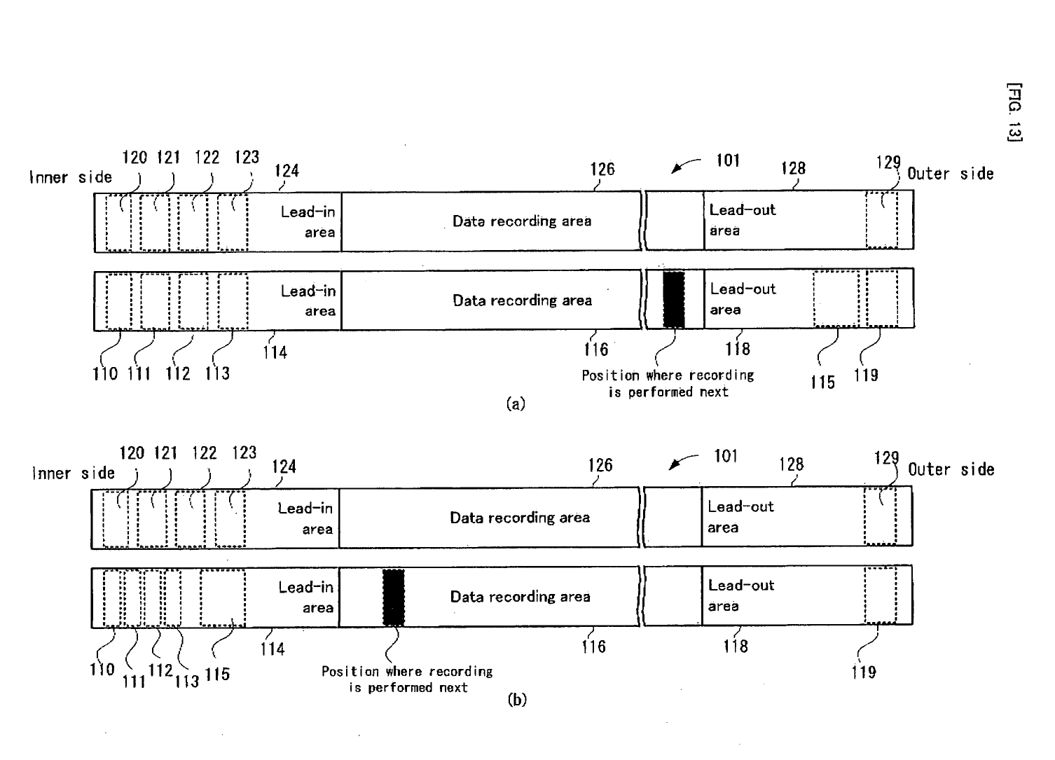

Next, with reference to FIG. 12 and FIG. 13, another operation example of the information recording apparatus 1 in the embodiment will be explained. FIG. 12 is a flowchart showing a flow of the actual data OPC process, in another recording operation of the information recording apparatus in the embodiment. FIG. 13 are data structure diagrams conceptually showing the data structure of the optical disc 101 during another recording operation. Incidentally, the same constituent elements as in the case of the information recording apparatus 1 in the embodiment carry the same reference numerals or step numbers, and the detailed explanation thereof is omitted.

Incidentally, with regard to the operation associated with a modified example, the actual data OPC is performed not in the data recording area 106 but in another area (e.g. the lead-in area 104 and the lead-out area 108, which are one specific example of the “management information area” of the present invention, or the like). Incidentally, as the premise of the actual data OPC process, the recording operation shown in FIG. 3 is also performed in this another operation example.

As shown in FIG. 12, firstly, a nearby management information area is designated as the recording position (step S301). For example, if the lead-in area 114 is closer to the position where the content data is recorded next than the lead-out area 118, the lead-in area 114 is designated to perform the actual data OPC. Alternatively, if the lead-out area 118 is closer to the position where the content data is recorded next than the lead-in area 114, the lead-out area 118 is designated to perform the actual data OPC. Another method other than this may be used to designate the management information area.

After that, the actual data is recorded into the designated management information area (i.e. the lead-in area 114 or the lead-out area 118) (the step S202). After this, in the same manner as the process in the above-mentioned FIG. 5, the parameters are measured (the step S203), and the optimum value is obtained (the step S204), and the recording power of the optical pickup 501 is set (the step S206).

As described above, by recording the actual data into the management information area, it is possible to record the actual data for obtaining the optimum value, which is originally not the content data, separately from the content data. Therefore, for example, it is possible to prevent such a disadvantage that the actual data is incorrectly accessed and the reproduction of the content data is hindered during reproduction of the content data.

Incidentally, since the management information area is not an area where the content data or the like is recorded, it is unnecessary to register the area where the actual data is recorded, as the unusable area (defect area or unallocated area). However, even in the management information area, the area where the actual data is recorded may be registered as the unusable area.

Next, in FIG. 13, the data structure on the optical disc in this another operation example will be explained. As shown in FIG. 13(a), on the optical disc 101 of a parallel track path type, if the area 116a where the content data is recorded next is relatively dose to the lead-out area 118, for example, the actual data OPC is performed in the partial area 115 of the lead-out area 118. On the other hand, as shown in FIG. 13(b), the area 116a where the content data is recorded next is relatively close to the lead-in area 114, the actual data OPC is performed in the partial area 115 of the lead-in area 114. By this, it is possible to obtain the more preferable optimum value even if the actual data OPC is performed by using the management information area.

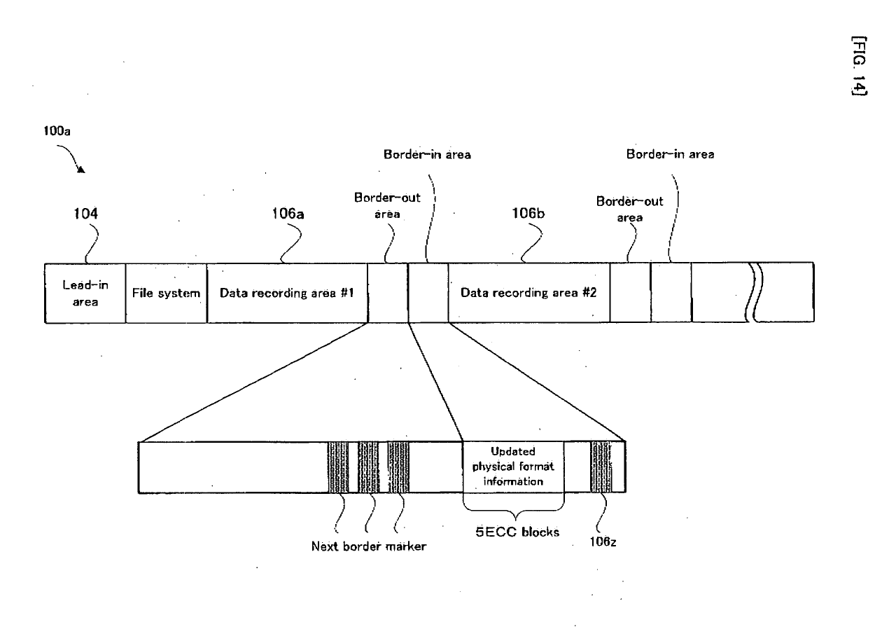

Moreover, as shown in FIG. 14, in the case of a Multi Border optical disc on which data can be additionally recorded, it may be constructed to record the actual data into a border zone. Specifically, this will be explained with reference to FIG. 14. FIG. 14 is an explanatory view conceptually showing the data structure of the Multi Border optical disc.

As shown in FIG. 14, a Multi Border optical disc 100a is provided with a border-in area and a border-out area, which are one specific example of the “additional recording management area” of the present invention, in addition to the data structure owned by the above-mentioned optical disc 100. Then, after data is once recorded into a data recording area #1, a border close process is performed in order to generate the border-in area and the border-out area. By this, it is possible to reproduce the information recorded on the optical disc, on the information reproducing apparatus, such as a Multi Border DVD-ROM player, for example. This is because the same data structure as that of the above-mentioned optical disc 100 can be adopted by using the border-in area (however, the file system in the case of the data recording area #1 instead of the border-in area), the data recording area, and the border-out area.

In the border-out area, there are recorded next border markers. The information recording apparatus 1 can recognize whether or not the data is recorded in an area following the next border out area by referring to the next border markers. Moreover, in the border-in area, there is recorded the same information as updated physical format information recorded in the lead-in area 104.

In the Multi Border optical disc 100a, the above-mentioned actual data OPC may be performed in the border-in area or the border-out area. At this time, the actual data OPC is preferably performed in the border-in area or the border-out area, which is adjacent to or close to the data recording area into which the data is to be recorded next. Specifically, if the data is recorded into a data recording area #2 next, the actual data OPC is preferably performed in a recording area 106z included in the border-in area of the data recording area #2. Of course, it is obvious that the actual data OPC may be performed in the border-out area. In particular, “00h” data or the like is recorded in the recording area of the border-out area where necessary information, such as the next border markers, is not recorded. Thus, there is such an advantage that the recording capacity of the optical disc 100a can be efficiently used, by performing the actual data OPC in the above-mentioned recording area before “00h” data is recorded.

Incidentally, in the above-mentioned embodiment, the optical disc 100 is explained as one example of the information recording medium, and the player related to the optical disc 100 is explained as one example of the information reproducing apparatus. The present invention, however, is not limited to the optical disc and the player thereof, and can be also applied to various information recording media supporting other high-density recording and high transfer rate and the player thereof.

The present invention is not limited to the above-described embodiment, and various changes may be made, if desired, without departing from the essence or spirit of the invention which can be read from the claims and the entire specification. An information recording medium, an information reproducing apparatus, an information reproducing method, and a computer program for reproduction control, which involve such changes, are also intended to be within the technical scope of the present invention.

### INDUSTRIAL APPLICABILITY

The information recording apparatus and method, and the computer program of the present invention can be applied to a DVD recorder or the like, for example. Moreover, they can be also applied to an information recording apparatus and the like, which are mounted on or which can be connected to various computer equipment for consumer use or for business use, for example.

1. An information recording apparatus comprising:
a recording device for recording information onto an information recording medium by using laser for recording with an adjustable recording power:
an optimizing device for recording actual data corresponding used when said recording device records the information, while at least changing the recording power in a plurality of ways by using the laser for recording by controlling said recording device, and for obtaining an optimum value of the recording power; and
an adjusting device for adjusting the recording power of said recording device to be the obtained optimum value.

2. The information recording apparatus according to claim 1, further comprising a calibrating device for obtaining a calibration value of the recording power by using a predetermined recording pattern, said optimizing device changing the recording power obtained by said calibrating device.

3. The information recording apparatus according to claim 1, wherein said optimizing device records the optimum value onto the information recording medium together with apparatus identification information, by controlling said recording device.

4. The information recording apparatus according to claim 2, wherein said optimizing device changes the recording power in a plurality of was on the basis of the obtained optimum value when the obtained optimum value is recorded on the information recording medium.

5. The information recording apparatus according to claim 4, wherein said optimizing device changes the recording power in a plurality of ways on the basis of the obtained calibration value when the obtained optimum value is not recorded but the obtained calibration value is recorded on the information recording medium.

6. The information recording apparatus according to claim 1, wherein said optimizing device obtains the optimum value by recording the actual data into a data recording area which is a portion where content information out of the information is recorded.

7. The information recording apparatus according to claim 6, wherein said optimizing device obtains the optimum value by recording the actual data into a data recording area which is located in the data recording area and which is adjacent to a recording area where the information is to be recorded by said recording device after the optimum value is obtained.

8. The information recording apparatus according to claim 6, further comprising:
a judging device for judging whether or not reproduction cam be performed in the portion where the actual data is recorded; and a controlling said recording device to register the portion where the actual data is recorded, as an unusable area, if it is judged that reproduction cannot be performed by the judging device.

9. The information recording apparatus according to claim 8, wherein the information recording medium is a multilayer information recording medium, and said controlling device controls said recording device to also register a recording area in another layer corresponding to the recording area in one layer, where the actual data is recorded, which is registered as the unusable area, as an unusable area.

10. The information recording apparatus according to claim 8, wherein said judging device judges that reproduction cannot be performed if said optimizing device records the actual data with a larger value of recording power than the optimum value.

11. The information recording apparatus according to claim 1, wherein said optimizing device obtains the optimum value by recording the actual data into a management information area which is a portion where management information about reproduction of content information is recorded out of the information.

12. The information recording apparatus according to claim 11, wherein the information recording medium comprises a plurality of management information areas, and said optimizing device records that actual data into one management information area relatively close to a recoding area where the information is to be recorded by said recording device after the optimum value is obtained, out of plurality of management information areas.

13. The information recording apparatus according to claim 1, wherein the information recording medium comprises an additional recording management area related to additional recording of the information, and said optimizing device obtains the optimum value by recording the actual data into the additional recording management area adjacent to a data recording area where the information to be additionally recorded is recorded.

14. The information recording apparatus according to claim 1, wherein said optimizing device obtains the optimum value by measuring at least one of jitter and asymmetry, which are obtained by reading the actual data, and a reading error rate when the actual data is read.

15. The information recording apparatus according to claim 1, wherein said optimizing device records the optimum value onto the information recording medium by controlling said recording device.

16. An information recording method in an information recording apparatus comprising; a recording device for recording information onto an information recording medium by using laser for recording with an adjustable recording power, said information recording method comprising: an optimizing process of recording actual data corresponding data used when said recording device records the information, while at least changing the recording power in a plurality of ways by using the laser for recording by controlling said recording device, and of obtaining an optimum value of the recording power; and
an adjusting process of adjusting the recording power of said recording device to be the obtained optimum value.

17. A computer program product in a computer-readable medium for tangible embodying a program of instructions executable by a computer provided in an information recording apparatus, said computer program product making the computer function as at least one portion of a recording device, an optimizing device and an adjusting device
said information recording apparatus comprising:
said recording device for recording information onto an information recording medium by using laser for recording with an adjustable recording power;
said optimizing device for recording actual data corresponding data used when said recording device records the information, while at least changing the recording power in a plurality of ways by using the laser for recording by controlling said recording device, and for obtaining an optimum value of the recording power; and
said adjusting device for adjusting the recording power of said recording device to be the obtained optimum value.
